(19) United States
(12) Patent Application Publication
(10) Pub. No.: US 2013/0127798 A1
(43) Pub. Date: May 23, 2013

(54) DRIVING METHOD FOR DISPLAY PANEL BY DIVIDING SCAN LINES INTO GROUPS AND ADJUSTING SCAN SEQUENCES

(71) Applicants: Wei-Han Chen, Hsin-Chu (TW); Yun-Chung Lin, Hsin-Chu (TW); I-Hsiang Chen, Hsin-Chu (TW); Chun-Yu Huang, Hsin-Chu (TW); Xian-Liang Liao, Hsin-Chu (TW); Chung-Lung Li, Hsin-Chu (TW)

(72) Inventors: Wei-Han Chen, Hsin-Chu (TW); Yun-Chung Lin, Hsin-Chu (TW); I-Hsiang Chen, Hsin-Chu (TW); Chun-Yu Huang, Hsin-Chu (TW); Xian-Liang Liao, Hsin-Chu (TW); Chung-Lung Li, Hsin-Chu (TW)

(21) Appl. No.: 13/481,882

(22) Filed: May 28, 2012

(30) Foreign Application Priority Data
Nov. 18, 2011 (TW) 100142434

(51) Int. Cl. G06F 3/038

(52) U.S. Cl. 345/204

(57) ABSTRACT

A driving method for a display panel is provided. The display panel includes a plurality of data lines, a plurality of scan lines, and a plurality of pixel units coupled to the data lines and the scan lines. The data lines are arranged to input an image data to the pixel units. The scan lines have groups of scan lines, and pixel units coupled to each group of scan lines are coupled to the same data line. The driving method includes: during a first and a second frame, scanning the scan lines one by one in a first and a second scan sequence to enable the pixel units, respectively, wherein the second scan sequence is different from the first scan sequence, and the scan sequence of each group of scan lines in the first scan sequence is different from that in the second scan sequence.

### BACKGROUND

1. Technical Field

The disclosed embodiments of the present invention relate to a driving scheme for a display panel, and more particularly, to a driving method for driving a display panel by dividing scan lines into groups and adjusting scan sequences.

2. Description of the Related Art

Regarding to a display panel having the half source driving (HSD) structure, the number of data lines required in driving the display panel is reduced by having two adjacent pixels share the same data line, thus lowing the production cost. Please refer to FIG. 1, which is a diagram illustrating partial circuitry of a conventional display 100 having the HSD structure. The display 100 includes a plurality of scan lines G1-G4, a plurality of data lines D1-D2, and a plurality of pixel units 110_1-110_8. The pixel units 110_1-110_8 include transistors M1-M8 and capacitors C1-C8, respectively, and the capacitors C1-C8 are coupled between the transistors M1-M8 and a common electrode voltage V_{COM}, respectively. As shown in FIG. 1, pixel units (e.g., the pixel unit 110_1) driven by odd scan lines (e.g., the scan line G1) share the same data line (e.g., the data line D1) with pixel units (e.g., the pixel unit 110_2) driven by even scan lines (e.g., the scan line G2), wherein each pixel unit represents one of a red pixel, a green pixel, and a blue pixel, and includes a transistor and a storage capacitor. Taking the pixel unit 110_1 and 110_2 for example, the scan lines G1 and G2 are driven one by one to receive image data inputted from the data line D1 and store the received image data into the capacitors C1 and C2, respectively.

As two adjacent pixels unit share the same data line, a parasitic capacitance effect may be generated when the two adjacent pixels are enabled one by one by the corresponding odd scan lines and even scan lines to store the image data into the corresponding capacitors. Consequently, the stored image data may be affected. For example, in a case where the display panel 100 is operated to display a green picture, the pixel units 110_1 and 110_4 representative of green pixels may be enabled by the scan lines G1 and G2, respectively, to store the received image data into the capacitors C1 and C4, respectively. However, when the scan line G2 is driven to enable the pixel unit 110_4, the pixel unit 110_2 is also enabled by the scan line G2, which affects the received image data of the pixel unit 110_1 (i.e., a parasitic capacitance effect is generated between the pixel unit 110_1 and the pixel unit 110_2). Therefore, the brightness of the green picture displayed on the display panel 100 is not uniform. Regarding the whole display panel 100, there is a V-line mura phenomenon occurred.

In addition, what makes the brightness of the display panel non-uniform may be that the received image data is inputted with opposite polarities in sequence to the pixel unit. Please refer to FIG. 2, which is a timing diagram of a pixel electrode voltage V_{D} and a common electrode voltage V_{COM} in a conventional display panel. As shown in FIG. 2, when the display panel displays the same gray level under an ideal condition, a voltage difference between the pixel electrode voltage V_{D} and the common electrode voltage V_{COM} would keep unchanged. However, when the common electrode voltage V_{COM} varies (e.g., the original common electrode voltage V_{COM} changes to the common electrode voltage V′_{COM}), the aforementioned voltage difference varies correspondingly, resulting in non-uniform brightness of the display panel.

Thus, there is a need for a driving method to solve the problem of the non-uniform brightness of the display panel.

### SUMMARY

According to an embodiment of the present invention, an exemplary driving method for a display panel is provided. The display panel includes a plurality of data lines, a plurality of scan lines, and a plurality of pixel units coupled to the data lines and the scan lines. The data lines are arranged to input an image data to the pixel units. The scan lines have groups of scan lines. Pixel units coupled to each group of scan lines are coupled to the same data line. The driving method includes: during a first frame period, scanning the scan lines one by one in a first scan sequence to enable the pixel units; and during a second frame period, scanning the scan lines one by one in a second scan sequence to enable the pixel units, wherein the second scan sequence is different from the first scan sequence, and the scan sequence of each group of scan lines in the first scan sequence is different from that in the second scan sequence. The plurality of scan lines comprise a first group of scan lines and a second group of scan lines, the scan sequence of the first group of scan lines is different from that of the second group of scan lines in the first scan sequence, and the scan sequence of the first group of scan lines is different from that of the second group of scan lines in the second scan sequence.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating partial circuitry of a conventional display having the HSD structure.

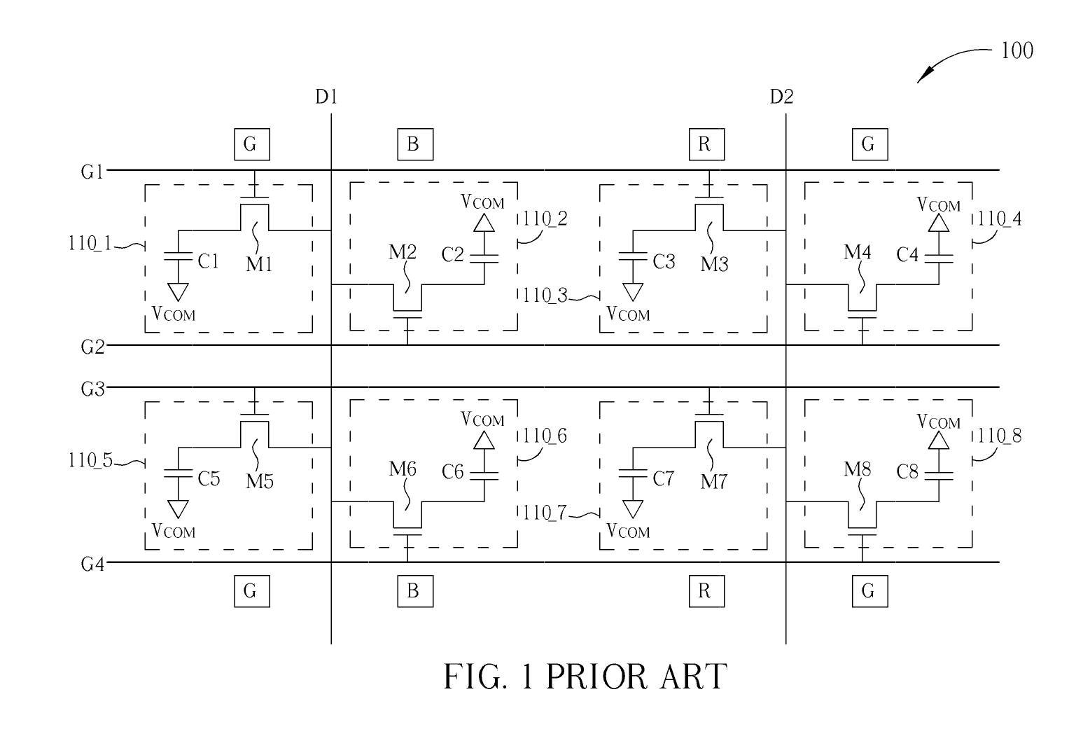

FIG. 2 is a timing diagram of a pixel electrode voltage and a common electrode voltage in a conventional display panel.

FIG. 3 is a diagram illustrating partial circuitry of an exemplary display panel according to an embodiment of the present invention.

FIG. 4 is a scanning timing diagram illustrating an exemplary driving method for the display panel shown in FIG. 3 according to an embodiment of the present invention.

FIG. 5 is a scanning timing diagram illustrating another exemplary driving method for the display panel shown in FIG. 3 according to another embodiment of the present invention.

FIG. 6A is a scanning timing diagram illustrating another exemplary driving method for the display panel shown in FIG. 3 according to another embodiment of the present invention.

FIG. 6B is a scanning timing diagram illustrating another exemplary driving method for the display panel shown in FIG. 3 according to another embodiment of the present invention.

FIG. 7 is a scanning timing diagram illustrating another exemplary driving method for the display panel shown in FIG. 3 according to another embodiment of the present invention.

### DETAILED DESCRIPTION

The disclosed driving method for a display panel may be applied to circuitry of any display panel whose display quality may be affected by the scan sequence and/or the voltage polarity of data input. However, for clarity and simplicity, the disclosed method is described as follows with reference to an exemplary display panel having a half source driving structure.

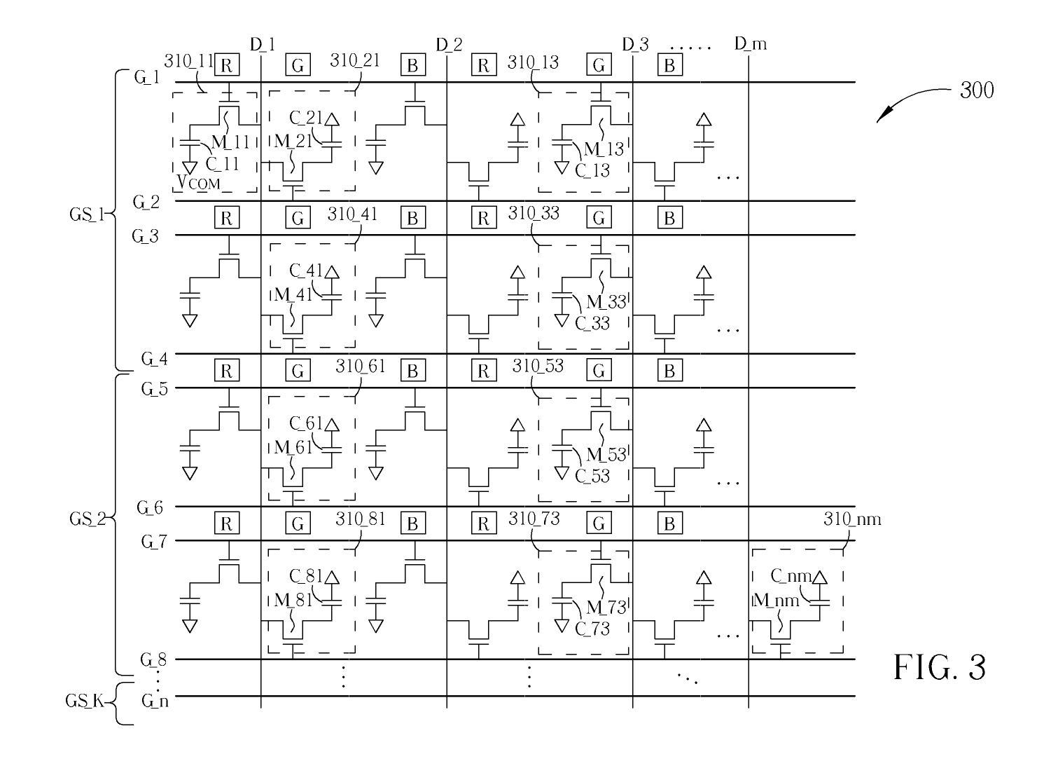

Please refer to FIG. 3, which is a diagram illustrating partial circuitry of an exemplary display panel according to an embodiment of the present invention. The display panel 300 includes, but is not limited to, a plurality of data lines D_1-D_n, a plurality of scan lines G_1-G_n, and a plurality of pixel units 310_11-310_{—}nm coupled to the data lines D_1-D_n and the scan lines G_1-G_n, wherein the pixel unit marked with “310_{—}nm” represents that it is coupled between the scan line G_n and the data line D_m, and both n and m are positive integers. Values of n and m may be adjusted according to the actual design considerations. Each pixel unit includes, but is not limited to, a transistor and a capacitor, wherein the capacitor is coupled between the transistor and a common electrode voltage. For example, the pixel unit 310_{—}nm includes a transistor M_nm and a capacitor C_nm, wherein the capacitor C_nm is coupled between the transistor M_nm and a common electrode voltage V_{COM}. The data lines D_1-D_m are arranged to input an image data to the pixel units 310_11-310_{—}nm. The scan lines G_1-G_n may be divided into a plurality of groups of scan lines GS_1-GS_k, where k is a positive integer. Pixel units coupled to each group of scan lines are coupled to the same data line. By way of example but not limitation, a first group of scan lines GS_1 among the groups of scan lines GS_1-GS_k is composed of the scan lines G1-G4, and a second group of scan lines GS_2 among the groups of scan lines GS_1-GS_k is composed of the scan lines G5-G8. In addition, the display panel 300 is driven by the line inversion driving scheme to input the image data the pixel units 310_11-310_{—}nm. It should be noted that this is for illustrative purposes only, and is not meant to be a limitation of the present invention. In other words, the number of the scan lines included in each group of the lines is not limited to 4, and the proposed driving method may also be applicable when the data lines D_1-D_m of the display panel 300 employs the dot inversion driving scheme, the line inversion driving scheme, or the frame inversion driving scheme to input the image data to the plurality of pixel units 310_11-310_{—}nm. Examples of the scanning timing of the first group of scan lines GS_1 and the second group of scan lines GS_2 are given below for describing the driving method of the display panel 300.

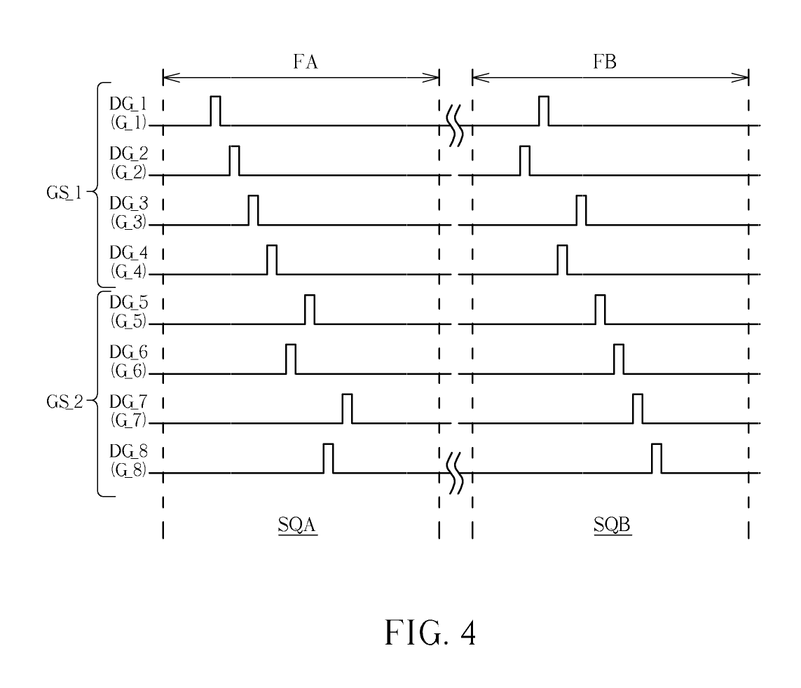

Please refer to the FIG. 4 in conjunction with the FIG. 3. FIG. 4 is a scanning timing diagram illustrating an exemplary driving method for the display panel shown in FIG. 3 according to an embodiment of the present invention. In this embodiment, first, during a frame period FA, the scan lines G_1, G_2, G_3, G_4, G_6, G_5, G_8, and G_7 are scanned one by one in a scan sequence SQA to enable the corresponding pixel units. Next, during a frame period FB, the scan lines G_2, G_1, G_4, G_3, G_5, G_6, G_7, and G_8 are scanned one by one in a scan sequence SQB to enable the corresponding pixel units, wherein the scan sequence SQB is different from the scan sequence SQA, and the scan sequence of each group of scan lines in the scan sequence SQA is different from that in the scan sequence SQB. Besides, as shown in FIG. 4, the scan sequence of the first group of scan lines GS_1 is different from that of the second group of scan lines GS_2 in the scan sequence SQA, and the scan sequence of the first group of scan lines GS_1 is different from that of the second group of scan lines GS_2 in the scan sequence SQB. In this embodiment, the scan lines G_1-G_8 are driven by the corresponding gate driving signals DG_1-DG_8 generated from a gate driver (not shown in FIG. 3) of the display panel 300, respectively.

By way of example, but not limitation, in a case where the display panel 300 displays the full green image, the enabling sequences of the pixel units 310_21, 310_41, 310_61, 310_81, 310_13, 310_33, 310_53, and 310_73 (representative of green colors) are described as follows. During the frame period FA, regarding the pixel units in the same row of the display picture in the first group of the lines GS_1 (e.g., the pixel unit 310_21 and the pixel unit 310_13), the scan sequence of the first group of the lines GS_1 in the scan sequence SQA is to enable the pixel unit 310_13 corresponding to the odd scan line G_1 first and then the pixel unit 310_21 corresponding to the even scan line G_2. In addition, regarding the pixel units in the another row of the display picture in the first group of the lines GS1 (e.g., the pixel unit 310_41 and the pixel unit 310_33), the pixel unit 310_33 corresponding to the odd scan line G_3 is enabled first, and then the pixel unit 310_41 corresponding to the even scan line G_4 is enabled. To put it another way, regarding the pixel units in the same row of the display picture in the first group of the lines GS_1, the pixel unit corresponding to the odd scan line is enabled before the pixel unit corresponding to the even scan line in the scan sequence SQA.

Regarding the pixel units in the same row of the display picture in the second group of the lines GS_2 (e.g., the pixel unit 310_61 and the pixel unit 310_53), the scan sequence of the second group of the lines GS_2 in the scan sequence SQA is to enable the pixel unit 310_61 corresponding to the even scan line G_6 first and then the pixel unit 310_53 corresponding to the odd scan line G_5. In addition, regarding the pixel units in the another row of the display picture in the second group of the lines GS_2 (e.g., the pixel unit 310_81 and the pixel unit 310_73), the pixel unit 310_81 corresponding to the even-row scan line G_8 is enabled first, and then the pixel unit 310_73 corresponding to the odd scan line G_7 is enabled. To put it another way, regarding the pixel units in the same row of the display picture in the second group of the lines GS_2, the pixel unit corresponding to the even scan line is enabled before the pixel unit corresponding to the odd scan line in the scan sequence SQA.

In addition, during the frame period FB (corresponding the scan sequence SQB), regarding the pixel units in the same row (e.g., the pixel unit 310_21 and the pixel unit 310_13) of the display picture in the first group of the lines GS_1, the pixel unit corresponding to the even scan line (e.g., the pixel unit 310_21) is enabled before the pixel unit corresponding to the odd scan line (e.g., the pixel unit 310_13). Regarding the pixel units in the same row (e.g., the pixel unit 310_61 and the pixel unit 310_53) of the display picture in the second group of the lines GS_2, the pixel unit corresponding to the odd scan line (e.g., the pixel unit 310_53) is enabled before the pixel unit corresponding to the even scan line (e.g., the pixel unit 310_61). Therefore, regarding the pixel units corresponding to the same group of scan lines, the enabling sequence of the pixel units corresponding to the odd scan lines (e.g., the pixel unit 310_13) and the even scan lines (e.g., the pixel unit 310_21) during the frame period FA is different from that during the frame period FB, which may compensate the aforementioned non-uniform brightness of the green image generated due to the scan sequence. Besides, regarding the pixel units corresponding to the same data line (i.e., the vertical display picture), the disclosed driving method in this embodiment also has brightness compensation capability. For example, during the frame period FA, the pixel unit 310_21 is enabled later as compared to the pixel unit 310_13, and the pixel unit 310_61 is enabled earlier as compared to the pixel unit 310_53; during the frame period FB, the pixel unit 310_21 is enabled earlier as compared to the pixel unit 310_13, and the pixel unit 310_61 is enabled later as compared to the pixel unit 310_53. Therefore, the green image brightness of the pixel units, which correspond to the first group of the lines GS_1 and share the data line D1, and the green image brightness of the pixel units, which correspond to the second group of the lines GS_2 and share the data line D1, may compensate each other.

From the above description, the exemplary driving method shown in FIG. 4 may be briefly summarized as follows: during a first frame period (e.g., the frame period FA shown in FIG. 4), scanning the scan lines one by one in a first scan sequence (e.g., the scan sequence SQA shown in FIG. 4) to enable the pixel units; and during a second frame period (e.g., the frame period FB shown in FIG. 4), scanning the scan lines one by one in a second scan sequence (e.g., the scan sequence SQB shown in FIG. 4) to enable the pixel units, wherein the second scan sequence is different from the first scan sequence, and the scan sequence of each group of scan lines in the first scan sequence is different from that in the second scan sequence. In addition, the scan lines include a first group of scan lines and a group of second scan lines, the scan sequence of the first group of scan lines is different from that of the second group of scan lines in the first scan sequence, and the scan sequence of the first group of scan lines is different from that of the second group of scan lines in the second scan sequence.

A first frame driven during the aforementioned first frame period and a second frame driven during the aforementioned second frame period may be discontinuous frames. For example, a frame driven during the frame period FA shown in FIG. 4 and a frame driven during the frame period FB shown in FIG. 4 may be discontinuous frames. In other words, although pixel units may not be compensated in two continuous frame periods during a certain period in which the display panel 300 is under operation, non-uniform brightness viewing experience may still be reduced effectively for human eyes as long as the compensation is performed during a proper operation period in which the display panel 300 is under operation. Please note that even though not all the pixel units are compensated after the frame periods FA and FB due to the scan sequence setting, the spirit of the present invention is still obeyed as long as a driving method drives a display panel by dividing the scan lines into groups and adjusting the scan sequences. For example, in the scanning timing diagram shown in FIG. 4, even if the scan sequences of the scan lines G_1 and G_2 are the same during each of the frame periods FA and FB (e.g., during the frame period FB, the pixel unit 310_13 corresponding to the scan line G_1 is adjusted to be enabled before the pixel unit 310_21 corresponding to the scan line G_2, that is, the scan sequence SQB is adjusted to scan the scan lines G_1 , G_2, G_4, G_3, G_5, G_6, G_7, and G_8 one by one), the scan sequence of the first group of the lines GS_1 during the frame period FA is still different from that during the frame period FB. Besides, the scan sequence of the first group of the lines GS_1 is also different from that of the second group of the lines GS_2 during the above-mentioned two frame periods. Therefore, the spirit of the present invention is still obeyed.

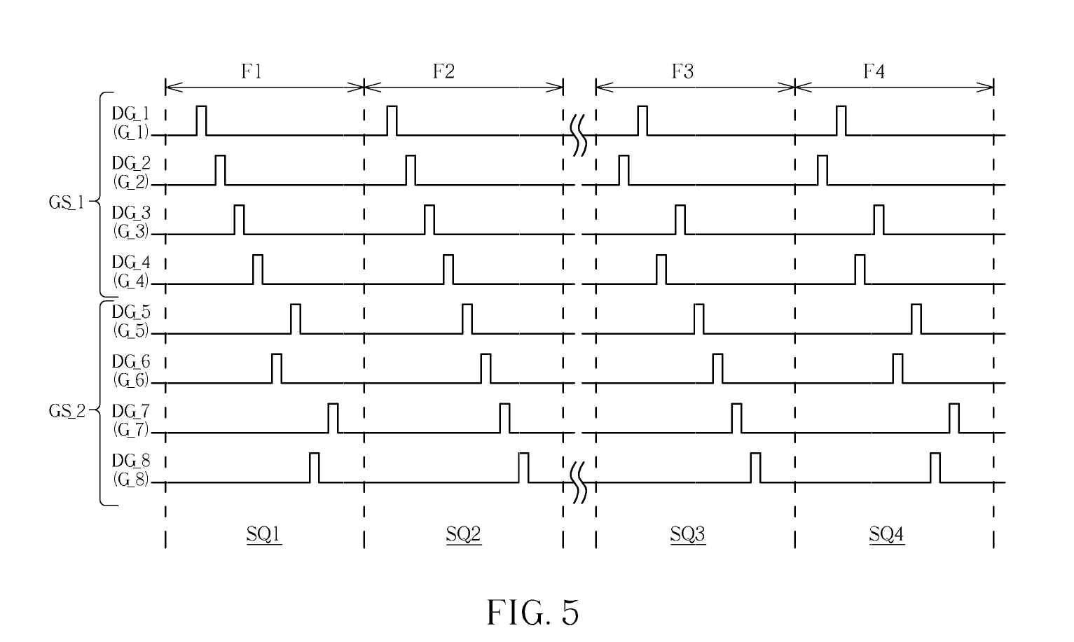

Please refer to FIG. 5 in conjunction with FIG. 3. FIG. 5 is a scanning timing diagram illustrating another exemplary driving method for the display panel shown in FIG. 3 according to another embodiment of the present invention. The exemplary driving method shown in FIG. 5 is based on the exemplary driving method shown in FIG. 4. In other words, a frame period F1 and a scan sequence SQ1 thereof as shown in FIG. 5 correspond to the frame period FA and the scan sequence SQA thereof as shown in FIG. 4, respectively, and a frame period F3 and a scan sequence SQ3 thereof as shown in FIG. 5 correspond to the frame period FB and the scan sequence SQB thereof as shown in FIG. 4, respectively. As can be known from FIG. 5, during a frame period F2 immediately following the frame period F1, a scan sequence SQ2 is employed to scan the scan lines G_1, G_2, G_3, G_4, G_5, G_6, G_7, and G_8 one by one in order to enable the pixel units 310_11-310_{—}nm. Moreover, regarding the pixel units in the same row (e.g., the pixel units 310_21 and 310_13) of the display picture, the scan sequence SQ2 enables the pixel units (e.g., the pixel unit 310_13) corresponding to the odd scan lines (e.g., the scan line G_1) first, and then enables the pixel units (e.g., the pixel unit 310_21) corresponding to the even scan lines (e.g., the scan line G_2). In addition, during a frame period F4 immediately following the frame period F3, a scan sequence SQ4 is employed to scan the scan lines G_2, G_1, G_4, G_3, G_6, G_5, G_8, and G_7 one by one in order to enable the pixel units 310_11-310_{—}nm. Moreover, regarding the pixel units in the same row (e.g., the pixel units 310_21 and 310_13) of the display picture, the scan sequence SQ4 enables the pixel units (e.g., the pixel unit 310_21) corresponding to the even scan lines (e.g., the scan line G_2) first, and then enables the pixel units (e.g., the pixel unit 310_13) corresponding to the odd scan lines (e.g., the scan line G_1). As can be understood from the above description, the frame driven during the frame period F1 and the frame driven during the frame period F2 are continuous frames, and the frame driven during the frame period F3 and the frame driven during the frame period F4 are continuous frames. Besides, the scan sequence SQ4 is different from the scan sequence SQ2, and the scan sequence of each group of scan lines in the scan sequence SQ2 is different from that in the scan sequence SQ4.

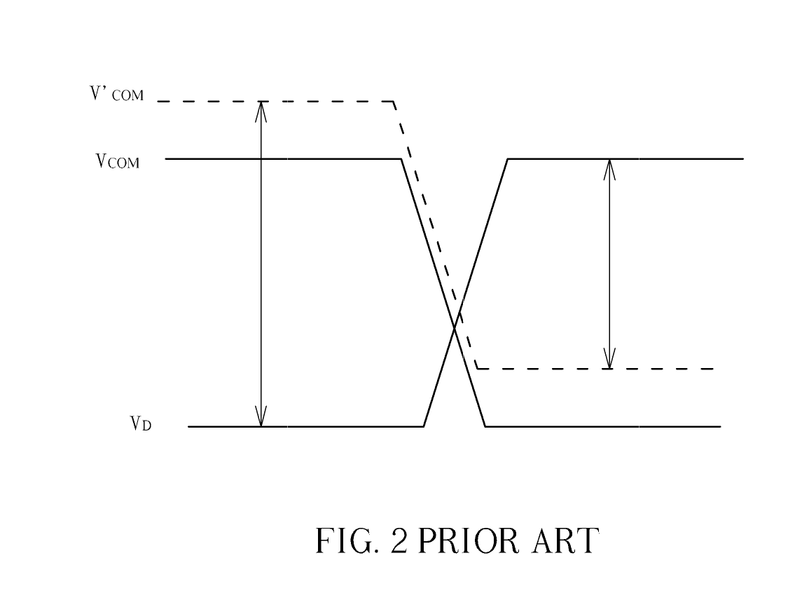

In general, in order to avoid damaging the property of the liquid crystal, the received image data may be inputted with opposite polarities to the same pixel unit during two continuous frames when pixel units are being driven. Therefore, in this embodiment, the scan sequence of each of the frame periods F1 and F2 is to enable the pixel unit 310_13 corresponding to the odd scan line G_1 first and then the pixel unit 310_21 corresponding to the even scan line G_2, which compensates the non-uniform brightness of the display picture due to the unstable common electrode voltage as shown in FIG. 2. For example, the common electrode voltage imposed upon the pixel unit 310_13 is identical to the common electrode voltage V_{COM} shown in FIG. 2, and the common electrode voltage imposed upon the pixel unit 310_21 is identical to the common electrode voltage V′_{COM} shown in FIG. 2. Thus, in the negative-polarity display (i.e., the common electrode voltage is higher than the display electrode voltage), the voltage difference imposed upon the pixel unit 310_21 would be larger than the voltage difference imposed upon the pixel unit 310_13. However, in the following positive-polarity display (i.e., the common electrode voltage is lower than the display electrode voltage), the voltage difference imposed upon the pixel unit 310_21 would be smaller than the voltage difference imposed upon the pixel unit 310_13. To put it simply, by employing the scan sequences SQ2 and SQ4 in this embodiment, the non-uniform brightness generated during the frame periods F2 and F4 as well as the non-uniform brightness generated due to the positive and negative polarity displays (e.g., the frame periods F1 and F2, or the frame periods F3 and F4) may be compensated.

As can be understood from the above description, the driving method shown in FIG. 5 is based on the driving method shown in FIG. 4. To put it another way, besides adopting the aforementioned first and second scan sequences (e.g., the scan sequences SQ1 and SQ3 corresponding to the scan sequences SQA and SQB shown in FIG. 4, respectively) to drive the display panel 300 during the aforementioned first and second frame periods (e.g., the frame periods F1 and F3 corresponding to the frame periods FA and FB shown in FIG. 4, respectively), the driving method shown in FIG. 5 further adopts a third scan sequence (e.g., the scan sequence SQ2 shown in FIG. 5) and a forth scan sequence (e.g., the scan sequence SQ4 shown in FIG. 5) to drive the display panel 300 during a third frame period (e.g., the frame period F2 shown in FIG. 5) and a forth scan sequence (e.g., the frame period F4 shown in FIG. 5), respectively. The driving method shown in FIG. 5 may be summarized as follows.

During the third frame period, scanning the scan lines one by one in the third scan sequence to enable the pixel units; and during a forth frame period, scanning the scan lines one by one in the forth scan sequence to enable the pixel units, wherein the first frame driven during the first frame period and the third frame driven during the third frame period are continuous frames, the second frame driven during the second frame period and the forth frame driven during the forth frame period are continuous frames, the forth scan sequence is different from the third scan sequence, and the scan sequence of each group of scan lines in the third scan sequence is different from that in the forth scan sequence. In addition, the scan sequence of the first group of scan lines is different from that of the second group of scan lines in the third scan sequence, and the scan sequence of the first group of scan lines is different from that of the second group of scan lines in the forth scan sequence.

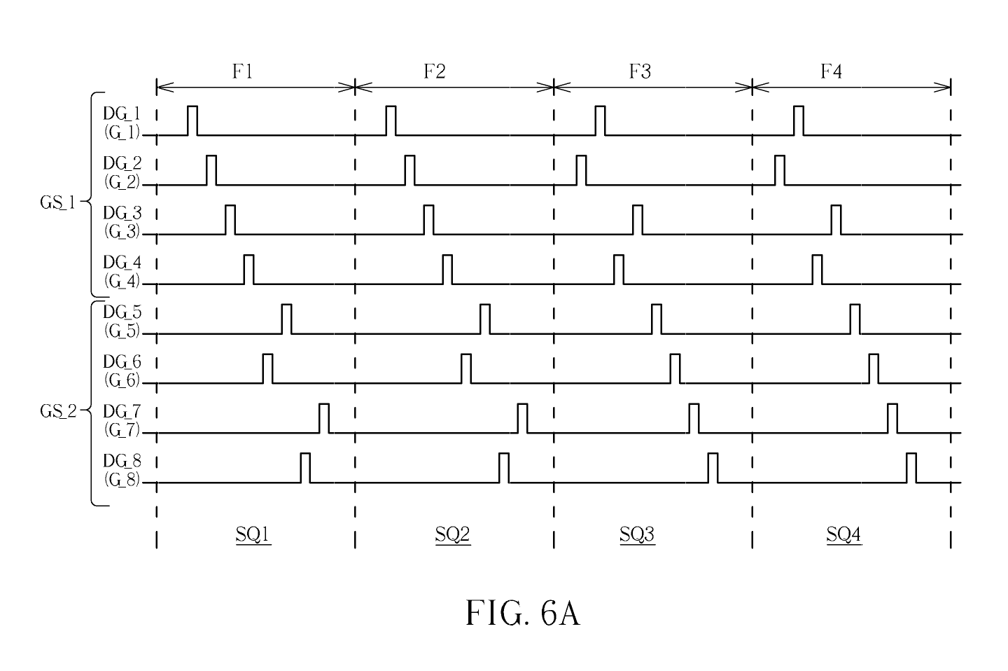

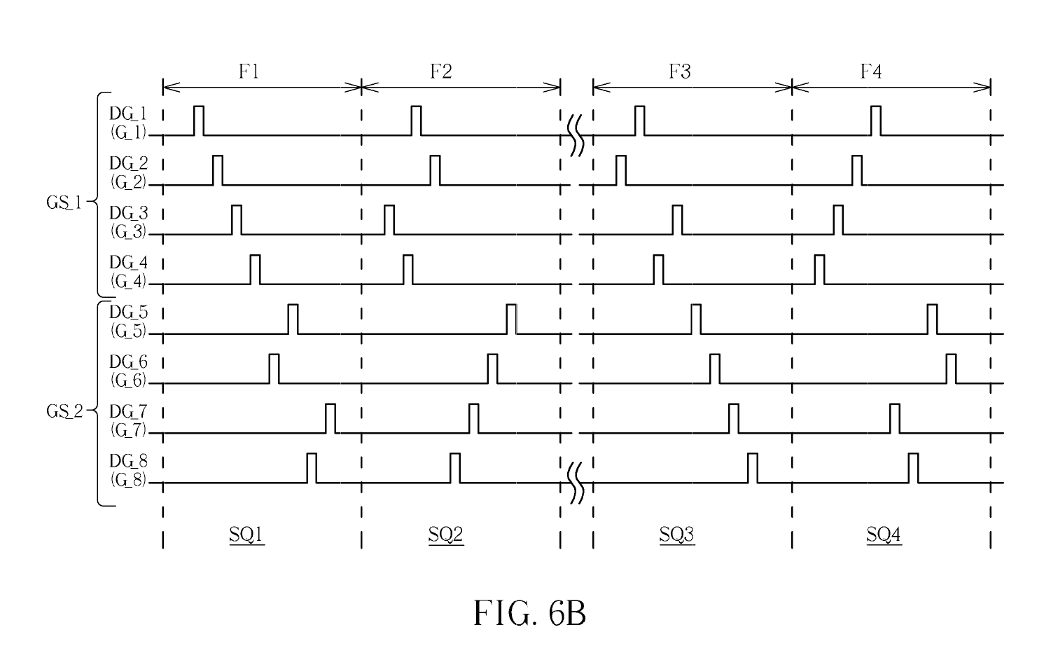

It should be noted that the third frame driven during the aforementioned third frame period and the second frame driven during the aforementioned second frame period may be continuous or discontinuous frames, the first scan sequence may be the same as the third scan sequence, and the second scan sequence may be the same as the forth scan sequence. Please refer to FIG. 6A, which is a scanning timing diagram illustrating another exemplary driving method for the display panel shown in FIG. 3 according to another embodiment of the present invention. The exemplary driving method shown in FIG. 6A is based on the exemplary driving methods shown in FIG. 4 and FIG. 5. In this embodiment, the scan sequence of the first group of scan lines GS_1 in the scan sequence SQ2 is different from that of the second group of scan lines GS_2 in the scan sequence SQ2, and the scan sequence of the first group of scan lines GS_1 in the scan sequence SQ4 is different from that of the second group of scan lines GS_2 in the scan sequence SQ4. Besides, the scan sequence SQl is the same as the scan sequence SQ2, the scan sequence SQ3 is the same as the scan sequence SQ4, and the frame driven during the frame period F2 and the frame driven during the frame period F3 are continuous frames. After reading above paragraphs directed to FIG. 3, FIG. 4, and FIG. 5, a person skilled in the art can readily understand that, by dividing the scan lines into groups and adjusting the scan sequences, the driving method shown in FIG. 6 may compensate the vertical and horizontal non-uniform brightness of the display picture generated in the frames driven during the frame periods F1 and F3 and in the frames driven during the frame periods F2 and F4. Besides, the driving method shown in FIG. 6 may further compensate the non-uniform brightness of the display picture that is generated in the frames driven during the frame periods F1 and F2 and in the frames driven during the frame periods F3 and F4, where the non-uniform brightness results from the image data inputted with opposite polarities to the pixel units. Therefore, further description is omitted here for brevity.

Please note that although the scan sequences SQ1 and SQ2 are identical to each other and the scan sequences SQ3 and SQ4 are identical to each other, this is not meant to be a limitation of the driving sequence of the scan lines G_1-G_8. Please refer to FIG. 6B, which is a scanning timing diagram illustrating another exemplary driving method for the display panel shown in FIG. 3 according to another embodiment of the present invention. The exemplary driving method shown in FIG. 6B is based on the exemplary driving methods shown in FIG. 4 and FIG. 5. In this embodiment, although the scan sequence SQ2 shown in FIG. 6B is to drive the scan lines G_3, G_4, G_1, G_2, G_8, G_7, G_6, and G_5 one by one, which is different from the driving sequence of the scan lines G_1-G_8 in the scan sequence SQ2 shown in 6A, each of the scan sequences drives the odd scan lines first in the first group of the lines GS_1, and drives the even scan lines first in the second group of the lines GS_2. Thus, the identical/similar effects provided by employing the driving method shown in FIG. 6A may also be achieved by employing the driving method shown in FIG. 6B. In this embodiment, the frame driven during the frame period F2 and the frame driven during the frame period F3 may be discontinuous frames.

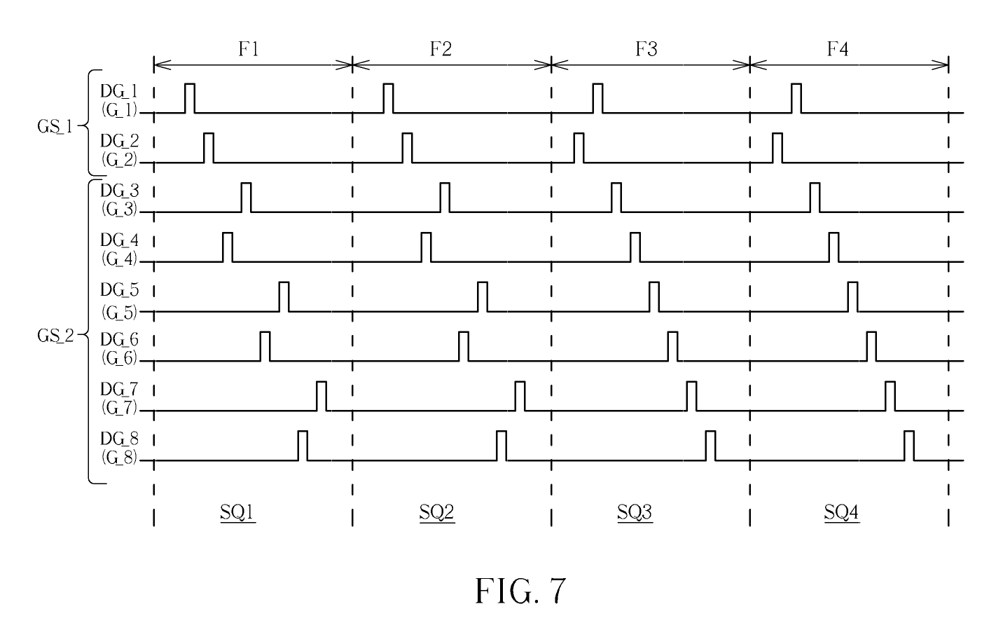

Please refer to FIG. 7, which is a scanning timing diagram illustrating another exemplary driving method for the display panel shown in FIG. 3 according to another embodiment of the present invention. The exemplary driving method shown in FIG. 7 is based on the exemplary driving method shown in FIG. 6A. In this embodiment, the first group of scan lines GS_1 is composed of the scan lines G1 and G2, and the second group of scan lines GS_2 is composed of the scan lines G3-G8. As a person skilled in the art can readily understand the operation of the driving method shown in FIG. 7 after reading above paragraphs directed to FIG. 3, FIG. 4, and FIG. 5, further description is omitted here for brevity. It should be noted that, as shown in FIG. 7, the number of each group of the scan lines may depend on the actual design consideration/requirement. In an alternative design, the first group of the scan lines GS_1 may also be composed of the scan lines G1, G2, G7, and G8. In other words, the groups of scan lines may include at least one group of scan lines which is composed of not totally adjacent scan lines. In another alternative design, only part of scan lines disposed on the display panel, rather than all scan lines disposed on the display panel, are divided into groups. In yet another alternative design, the scan lines included in the display panel 300 shown in FIG. 3 may also include group(s) of scan lines having odd scan lines.

The architecture of the display panel 300 shown in FIG. 3 is an HSD strip arrangement. In another embodiment, the architecture of the display panel 300 may also be an HSD delta arrangement. In addition, the proposed driving method is not limited to be applied to the display panel having the HSD structure. For example, as long as display quality of a display panel circuitry may be affected by the scan sequence or the voltage polarity of the data input, the proposed driving method may also be employed.

To sum up, a driving method for a display panel by dividing scan lines into groups and adjusting scan sequences is disclosed. The disclosed driving method may improve the vertical and horizontal non-uniform brightness of display pictures, and/or non-uniform brightness induced by the positive-polarity and negative-polarity displays. In addition, the disclosed driving method may be applied to different inversion driving schemes, and meets the requirement of lowering the production cost and maintaining good display quality when applied to a display panel having a half source driving structure. Furthermore, the disclosed driving method may improve the vertical and horizontal non-uniform brightness of display pictures, and/or non-uniform brightness induced by the positive-polarity and negative-polarity displays. In addition, the disclosed driving method may be applied to different inversion driving schemes, and meets the requirement of lowering the production cost and maintaining good display quality when applied to a display panel having a half source driving structure.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving method for a display panel, the display panel comprising a plurality of data lines, a plurality of scan lines, and a plurality of pixel units coupled to the data lines and the scan lines, the data lines being arranged to input an image data to the pixel units, the scan lines having a plurality of groups of scan lines, pixel units coupled to each group of scan lines being coupled to a same data line; the driving method comprising:
during a first frame period, scanning the scan lines one by one in a first scan sequence to enable the pixel units; and
during a second frame period, scanning the scan lines one by one in a second scan sequence to enable the pixel units, wherein the second scan sequence is different from the first scan sequence, and each group of scan lines has different scan sequences in the first scan sequence and the second scan sequence;
wherein the groups of scan lines comprise a first group of scan lines and a second group of scan lines, a scan sequence of the first group of scan lines in the first scan sequence is different from a scan sequence of the second group of scan lines in the first scan sequence, and a scan sequence of the first group of scan lines in the second scan sequence is different from a scan sequence of the second group of scan lines in the second scan sequence.

2. The driving method of claim 1, wherein a first frame driven during the first frame period and a second frame driven during the second frame period are discontinuous frames.

3. The driving method of claim 1, further comprising:
during a third frame period, scanning the scan lines one by one in a third scan sequence to enable the pixel units; and
during a forth frame period, scanning the scan lines one by one in a forth scan sequence to enable the pixel units, wherein a first frame driven during the first frame period and a third frame driven during the third frame period are continuous frames, a second frame driven during the second frame period and a forth frame driven during the forth frame period are continuous frames, the forth scan sequence is different from the third scan sequence, and each group of scan lines have different scan sequences in the third scan sequence and the forth scan sequence.

4. The driving method of claim 3, wherein a scan sequence of the first group of scan lines in the third scan sequence is different from a scan sequence of the second group of scan lines in the third scan sequence, and a scan sequence of the first group of scan lines in the forth scan sequence is different from a scan sequence of the second group of scan lines in the forth scan sequence.

5. The driving method of claim 3, wherein the first scan sequence is identical to the third scan sequence, and the second scan sequence is identical to the forth scan sequence.

6. The driving method of claim 1, wherein the display panel has a half source driving structure.

7. The driving method of claim 1, wherein the data lines are driven by a dot inversion driving scheme, a line inversion driving scheme, or a frame inversion driving scheme to input the image data to the pixel units.
